(19) United States
(12) Patent Application Publication
(10) Pub. No.: US 2011/0276650 A1
(43) Pub. Date: Nov. 10, 2011

(54) SYSTEM, METHOD, APPARATUS, AND PROGRAM FOR DISTRIBUTING ADVERTISEMENT DATA

(75) Inventors: Yuzuru Tanaka, Tokyo (JP); Rei Hiramatsu, Tokyo (JP); Yu Higashiyama, Tokyo (JP); Kazuhiro Mitsuhashi, Tokyo (JP)

(73) Assignee: RSS ADS, INC., Tokyo (JP)

(21) Appl. No.: 12/419,524

(22) Filed: Apr. 7, 2009

(30) Foreign Application Priority Data
Nov. 30, 2008 (JP) 2008-305798

(51) Int. Cl. G06F 15/16

(52) U.S. Cl. 709/217

(57) ABSTRACT

A banner generating device 12 periodically obtains feeds from a Web server 11a, and generates banner data sets containing the obtained feeds and advertisement data sets relating to the feeds. The banner distribution server 13 periodically obtains banner data sets from a banner generating device 12. A terminal device 14a obtains a page data set from a Web server 11p, and displays a Web page 20 in accordance with the page data set. When the Web page 20 is displayed, the terminal device 14a obtains a banner data set that is required for displaying a banner in the Web page 20 from the banner distribution server 13. When the banner data set obtained from the banner distribution server 13 was generated by a banner generating device 12, the contents of the newest feeds and an advertisement are displayed as a banner at the terminal device 14a.

### FIELD OF THE INVENTION

The present invention relates to a system, method, apparatus, and program for distributing advertisements.

### BACKGROUND

The Internet is widely used as a medium for sending and receiving information. Some information distributed from Web sites through the Internet to the public, such as topical news data, is frequently updated. If the public is not notified of an update of information, the information may be overwritten by newer information before many people acknowledge it.

For the purpose of overcoming the above-mentioned problem, several data formats for distributing data are getting popular. For example, RSS (RDF Site Summary, Rich Site Summary, or Really Simple syndication) and Atom are well known as data formats for distributing data. When these data formats for distributing data are adopted, anybody who wishes to check updated data timely can let his/her terminal device show summaries of updated data periodically obtained from Web sites. Accordingly, he/she can recognize updates of data and read a brief overview of the updated data.

A ‘summary’ usually means a brief overview of updated data, but a ‘summary’ may be comprised of all of the updated data. A summary data set that is distributed to terminal devices and soon overwritten by a newer summary data set is generally called a ‘feed’. A program that instructs a terminal device to obtain feeds and display contents of the feeds is generally called a ‘feed reader’. Moreover, a user who lets his/her terminal device obtain feeds and display contents of the feeds is generally called a ‘subscriber’. A subscriber is not necessarily required to make any payment for subscribing to feeds.

A subscriber glances at a display of his/her terminal device each time a new feed is obtained by the terminal device. If advertisements are put between feeds, the advertisements are highly efficient since the subscriber frequently glances at the display to check the contents of new feeds. Accordingly, a system that adds an advertisement data set to a feed before the feed is distributed to the public is proposed.

### RELATED ART

Japanese Patent Application Publication No. 2007-526554 discloses a system in which an intermediate node, such as a proxy server, on a route of a network connection that is established between a subscriber's terminal device and a Web server for the terminal device to obtain feeds from the Web server, adds an advertisement data set to a feed obtained from the Web server. Then, the intermediate node transmits the feed with the advertisement data set to the terminal device.

According to the prior art, the intermediate node relaying data between the terminal device and the Web server is programmed to add an advertisement data set to a feed. (This function is referred to hereafter as a “function for adding advertisement” or “advertising supplement function”.) There may be a lot of possible routes of network connection between a terminal device and a Web server. Accordingly, in the prior art, it is necessary that each intermediate node be able to provide the advertising supplement function. Alternatively, in the prior art, it is necessary for each terminal device to access the Internet via a predetermined intermediate node that provides the advertising supplement function. Both of these requirements accompany a lot of changes in the existing system, and the prior art brings a lot of costs and inconveniences.

The present invention provides means for enabling efficient distribution of advertisement data sets via the Internet with no or few changes in the existing system.

### SUMMARY OF THE INVENTION

The present invention resides in one aspect in a system which includes a first storing unit which stores feeds, and a first transmitting unit which transmits feeds stored by the first storing unit. There is also a first storing unit that stores advertisement data sets, a first receiving unit that receives feeds from the first transmitting unit, a generating unit that generates part data sets from advertisement data sets stored by the first set storing unit and feeds received by the first receiving unit, and a second storing unit that stores part data sets generated by the generating unit. The system further includes a second receiving unit that receives requests for part data sets and a second transmitting unit that transmits part data sets stored by the second storing unit in response to requests received by the second receiving unit, to source nodes of the requests, the requests being transmitted from source nodes in accordance with instructions contained in page data sets received from a third transmitting unit. In addition, there is a third storing unit that stores page data sets, each of which contains an instruction to obtain a part data set stored by the second storing unit, and a third receiving unit that receives requests for page data sets, the requests being transmitted from arbitrary nodes. The third transmitting unit transmits page data sets stored by the third storing unit in response to requests received by the third receiving unit, to the arbitrary nodes.

The present invention resides in another aspect in a method which includes transmitting a feed from a first node to a second node, generating, at the second node, a data set from the feed and an advertisement data set stored at the second node, and storing the generated data set as a part data set, which indicates a part composing a page. A request for a page data set is transmitted from an arbitrary node to a third node, the third node being a node that distributes page data sets which include instructions to display web pages, in response to requests from arbitrary nodes. A page data set is transmitted from the third node to the arbitrary node in response to the request transmitted from the arbitrary node to the third node, the page data set containing an instruction to obtain the part data set. The method includes obtaining, at the arbitrary node, the part data set in accordance with the instruction contained in the page data set transmitted from the third node, and displaying, at the arbitrary node, a page containing a part indicated by the part data set.

The present invention resides in another aspect in an apparatus which includes an advertisement data set storing unit that stores advertisement data sets, a feed receiving unit that receives feeds from a first node; a generating unit that generates data sets from advertisement data sets stored by the advertisement data set storing unit and feeds received by the feed receiving unit, and a transmitting unit that transmits part data sets to source nodes of the requests for the part data sets.

The present invention resides in another aspect in a computer-readable storage medium having computer-executable code stored therein, the code being usable by a computer that has ability to communicate with external nodes via a network, including code for storing advertisement data sets, receiving feeds from a first node, generating data sets from the advertisement data sets and the feeds, and transmitting the generated data sets to a second node.

In one exemplary embodiment, the present invention provides a system which includes a first node that distributes feeds, a second node, a third node that distributes part data sets, each of which indicates a part composing a page, in response to requests from arbitrary nodes, and a fourth node that distributes page data sets, each of which instructs to display a page, in response to requests from arbitrary nodes. The first node has a storing unit that stores feeds, and a transmitting unit that transmits feeds stored by the storing unit of the first unit to the second node. The second node has a storing unit that stores advertisement data sets, a receiving unit that receives feeds from the first node, a generating unit that generates part data sets using advertisement data sets stored by the storing unit of the second node and feeds received by the receiving unit of the second node, and a transmitting unit that transmits part data sets generated by the generating unit of the second node to a third node. The third node has a part data set receiving unit that receives part data sets from the second node, a storing unit that stores part data sets received by the part data set receiving unit, a request receiving unit that receives requests for part data sets, the requests being transmitted from arbitrary nodes in accordance with instructions contained in page data sets received from the fourth node, and a transmitting unit that transmits, in response to requests received by the request receiving unit, part data sets stored by the storing unit of the third node to source nodes of the requests. The fourth node has a storing unit that stores page data sets each of which contains an instruction to obtain a part data set stored by the third node, a receiving unit that receives requests for page data sets, the requests being transmitted from arbitrary nodes, and a transmitting unit that transmits page data sets stored by the storing unit of the fourth node in response to requests received by the receiving unit of the fourth node to source nodes of the requests. (This exemplary embodiment is called embodiment 1 in this section.)

In a related embodiment, the third node and the fourth node may be a same node. (This related embodiment is called embodiment 2 in this section.)

In another exemplary embodiment, the invention provides a system which includes a first node that distributes feeds, a second node, and a third node that distributes page data sets, each of which instructs to display a page, in response to requests from arbitrary nodes. The first node has a storing unit that stores feeds, and a transmitting unit that transmits feeds stored by the storing unit of the first node to a second node. The second node has an advertisement data set storing unit that stores advertisement data sets, a feed receiving unit that receives feeds from the first nodes, a generating unit that generates part data sets using advertisement data sets stored by the advertisement data set storing unit and feeds received by the feed receiving unit, a part data set storing unit that stores part data sets generated by the generating unit, a request receiving unit that receives requests for part data sets, the requests being transmitted from arbitrary nodes in accordance with instructions contained in page data sets received from the third node, and a transmitting unit that transmits part data sets stored by the part data set storing unit in response to requests received by the request receiving unit to source nodes of the requests. In this embodiment the system includes a third node which has a storing unit that stores page data sets each of which contains an instruction to obtain a part data set stored by the second node, a receiving unit that receives requests for page data sets, the requests being transmitted from arbitrary nodes, and a transmitting unit that transmits page data sets stored by the storing unit of the third node in response to requests received by the receiving unit of the third node to source nodes of the requests. (This exemplary embodiment is called embodiment 3 in this section.)

In still another exemplary embodiment, the invention provides a method which includes transmitting a feed from a first node to a second node, generating, at the second node, a data set using the feed and an advertisement data set stored at the second node, and transmitting the data set generated at the second node from the second node to a third node as a part data set, which indicates a part composing a page, the third node being a node that distributes part data sets in response to requests from arbitrary nodes. The method further includes transmitting a request for a page data set from one arbitrary node to a fourth node, the fourth node being a node that distributes page data sets, each of which instructs to display a page, in response to requests from arbitrary nodes, and transmitting a page data set from the fourth node to the one arbitrary node in response to the request transmitted from the one arbitrary node to the fourth node, the page data set containing an instruction to obtain the part data set, which is generated at the second node and transmitted from the second node to the third node, from the third node. The method further includes obtaining, at the one arbitrary node, the part data set from the third node in accordance with the instruction contained in the page data set transmitted from the fourth node, and displaying, at the one arbitrary node, a page containing a part indicated by the part data set obtained from the third node. (This exemplary embodiment is called embodiment 4 in this section.)

In a related embodiment, the third node and the fourth node may be a same node. (This exemplary embodiment is called embodiment 5 in this section.)

In still another exemplary embodiment, the invention provides a method which includes transmitting a feed from a first node to a second node, generating, at the second node, a data set using the feed and an advertisement data set stored at the second node, and storing, at the second node, the data set generated at the second node as a part data set, which indicates a part composing a page. In this embodiment the method also includes transmitting a request for a page data set from one arbitrary node to a third node, the third node being a node that distributes page data sets, each of which instructs to display a page, in response to requests from arbitrary nodes, and transmitting a page data set from the third node to the one arbitrary node in response to the request transmitted from the one arbitrary node to the third node, the page data set containing an instruction to obtain the part data set, which is generated and stored at the second node, from the second node. This embodiment also includes obtaining, at the one arbitrary node, the part data set from the second node in accordance with the instruction contained in the page data set transmitted from the third node, and displaying, at the one arbitrary node, a page containing a part indicated by the part data set obtained from the second node. (This exemplary embodiment is called embodiment 6 in this section.)

According to the above mentioned systems or methods, the second node obtains feeds from the first node, for example using a well known feed reader, adds an advertisement data set to the collected feeds, and transmits the feeds containing the advertisement data set as a banner data set to a node that distributes banner data sets, or distributes the feeds containing the advertisement data set as a banner data set by itself in response to a request for a banner data set. As a result, feeds with an advertisement data set can be distributed to an arbitrary node such as a terminal device that accesses a Web site which provides a Web page containing a banner. Namely, according to the above explained system, an efficient advertisement distribution system can be achieved by adding the second node to an existing data distribution system.

In another aspect, the invention also provides an apparatus which has an advertisement data set storing unit that stores advertisement data sets, a feed receiving unit that receives feeds from a first node, a generating unit that generates data sets using advertisement data sets stored by the advertisement data set storing unit and feeds received by the feed receiving unit, and a transmitting unit that transmits the data sets generated by the generating unit to a second node as part data sets, each of which indicates a part composing a page, the second node being a node that distributes part data sets in response to requests from arbitrary nodes. (This exemplary embodiment is called embodiment 7 in this section.)

In one embodiment, the invention also provides an apparatus having an advertisement data set storing unit that stores advertisement data sets, a feed receiving unit that receives feeds from a first node, a generating unit that generates data sets using advertisement data sets stored by the advertisement data set storing unit and feeds received by the feed receiving unit, and a part data set storing unit that stores the data sets generated by the generating unit as part data sets, each of which indicates a part composing a page. The apparatus of this embodiment also includes a request receiving unit that receives requests for part data sets, each of the requests being transmitted from an arbitrary node in accordance with an instruction contained in a page data set that the arbitrary node obtains from another node, and a transmitting unit that transmits, in response to requests received by the request receiving unit, part data sets stored by the part data set storing unit to source nodes of the requests. (This exemplary embodiment is called embodiment 8 in this section.)

By adding the above mentioned apparatus to an existing data distribution system comprising a node for distributing feeds, a node for distributing banners, a node for distributing Web pages, etc., an efficient advertisement distribution system can be achieved.

In the apparatus of embodiment 7 or 8, the advertisement data set storing unit may store plural advertisement data sets. In addition, the feed receiving unit may receive feeds from the first node each time a predetermined condition is fulfilled. Each time the feed receiving unit receives feeds from the first node, the generating unit may select, from among the plural advertisement data sets stored by the advertisement data set storing unit, an advertisement data set that has a predetermined relationship with the received feeds, and generate the data set using the received feeds and the selected advertisement data set. (This exemplary embodiment is called embodiment 9 in this section.)

According to the above mentioned apparatus, data sets containing feeds and advertisement data sets that are related to each other are provided as part data sets to banner distribution nodes, etc., and a more efficient advertisement distribution system can be achieved.

In any one of embodiments 4 to 9, an advertisement data set may contain a network address of a Web server relating to the advertisement data set as a linked address. (This exemplary embodiment is called embodiment 10 in this section.)

According to the above mentioned apparatus, when a person who is interested in an advertisement operates, for example, a mouse to click an area where the advertisement is shown, a Web page relating to the advertisement is displayed, and therefore, a more efficient advertisement distribution system can be achieved.

In any one of embodiments 7 to 10, the generating unit may generate the data set which contains an instruction to transmit a beacon to the apparatus in addition to an advertisement data set and a feed, the beacon being a request for a picture data set accompanied by an identifier of the advertisement data set, and the apparatus may further include a beacon receiving unit that receives beacons from arbitrary nodes, and a counter that counts number of beacons that are received by the beacon receiving unit with respect to each identifier of advertisement data set accompanying the beacons. (This exemplary embodiment is called embodiment 11 in this section.)

According to the above mentioned apparatus, number of times of displays of each advertisement becomes available.

According to yet another aspect, the present invention also provides a program causing a computer that has ability to communicate with external nodes via a network to perform the steps of: storing advertisement data sets, receiving feeds from a first node, generating data sets using the advertisement data sets and the feeds, and transmitting the generated data sets to a second node as part data sets, each of which indicates a part composing a page, the second node being a node that distributes part data sets in response to requests from arbitrary nodes. (This exemplary embodiment is called embodiment 12 in this section.)

In another embodiment, the present invention also provides a program causing a computer that has ability to communicate with external nodes via a network to perform the steps of: storing advertisement data sets, receiving feeds from a predetermined node, generating data sets using the advertisement data sets and the feeds, and storing the generated data sets as part data sets, each of which indicates a part composing a page. In this embodiment the program also causes the computer to perform the steps of receiving requests for part data sets, each of the requests being transmitted from an arbitrary node in accordance with an instruction contained in a page data set that the arbitrary node obtains from another node, and transmitting, in response to the requests, the part data sets to source nodes of the requests. (This exemplary embodiment is called embodiment 13 in this section.)

According to embodiment 12 or 13, by adding a computer executing the program to an existing data distribution system comprising a node for distributing feeds, a node for distributing banners, a node for distributing Web pages, etc., an efficient advertisement distribution system can be achieved.

### BRIEF DESCRIPTION OF DRAWINGS

FIG. 1 illustrates an overall view of the configuration of an advertisement distribution system according to an exemplary embodiment of the present invention.

FIG. 2 illustrates a sample Web page produced in accordance with the exemplary embodiment of the present invention.

FIG. 3 illustrates a sample structure of a database for storing advertisement data sets 42 in the exemplary embodiment of the present invention.

FIG. 4 illustrates a sample banner displayed in accordance with a feed 41 banner data set 40 in the exemplary embodiment of the present invention.

FIG. 5 illustrates a sample structure of a database for managing banner data sets 40 in the exemplary embodiment of the present invention.

FIG. 6 illustrates a configuration diagram for explaining operations conducted in the exemplary embodiment of the present invention.

FIG. 7 illustrates a sample Web page displayed at a terminal device in the exemplary embodiment of the present invention.

### DETAILED DESCRIPTION

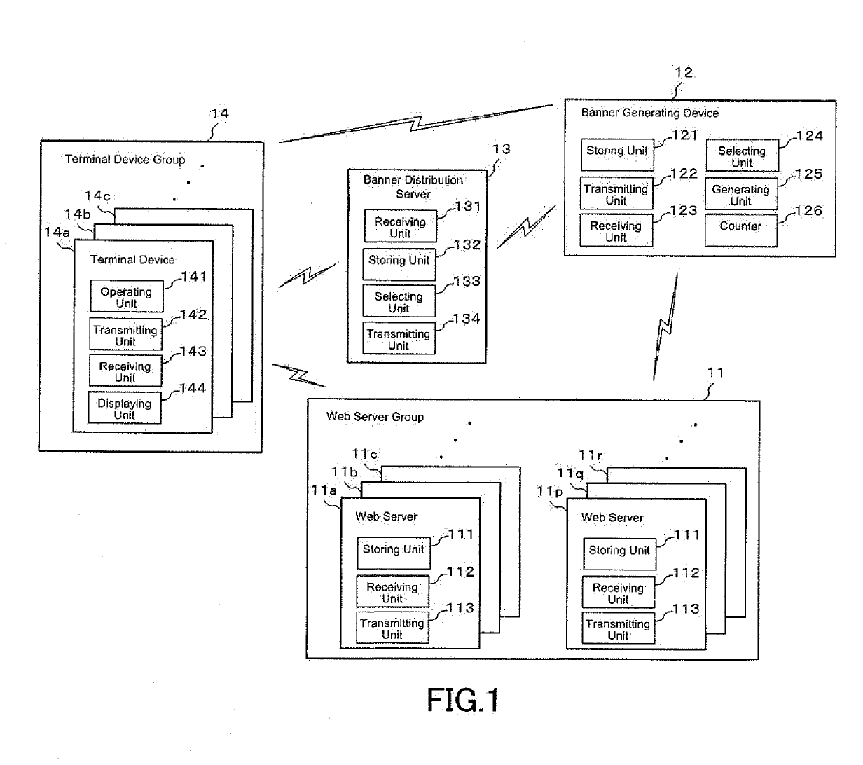

FIG. 1 illustrates an overall view of configuration of an advertisement distribution system 1, which is one exemplary embodiment of the present invention. The advertisement distribution system 1 comprises a Web server group 11, a banner generating device 12, a banner distribution server 13, and a terminal device group 14.

The Web server group 11 comprises a plurality of Web servers 11a, 11b, etc., each of which, in response to a request from any terminal device 14a, 14b, etc. in the terminal device group 14, transmits to the requesting terminal device via a network, e.g., the Internet, a page data set 44 that instructs a terminal device to display a Web page 20. The Web servers 11a, etc. in the Web server group 11 may or may not distribute feeds 41. For example, in FIG. 1, the Web servers 11a, 11b, and 11c distribute feeds 41, and the Web servers 11p, 11q, and 11r do not distribute feeds 41. However, the invention is not limited in this regard, as it will be understood that various combinations of servers which do or do not distribute feeds 41 can be used in other embodiments.

In one embodiment, a Web page 20 shown in accordance with a page data set 44 contains contents of feeds 41 and advertisements.

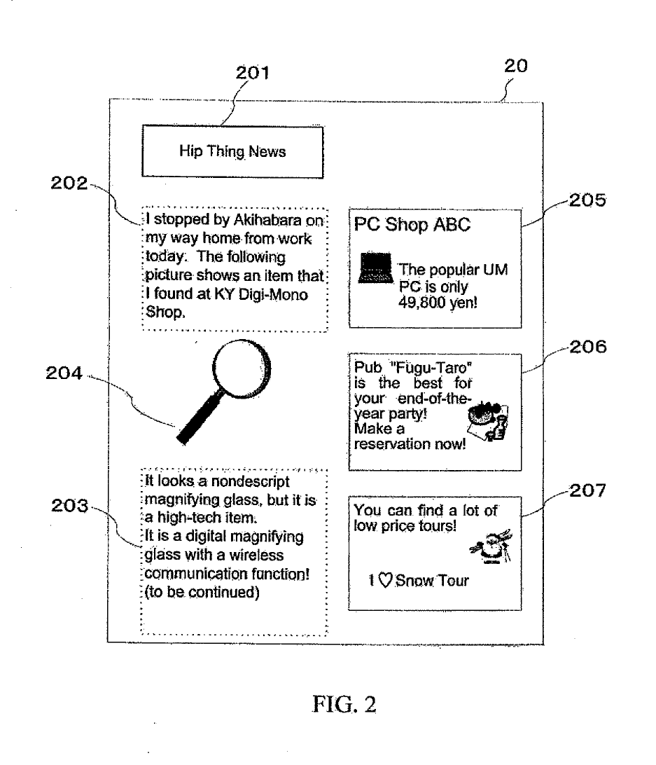

FIG. 2 illustrates the basic arrangement of a Web page 20 that is displayed by a terminal device 14a in accordance with a page data set 44 distributed from, for example, a Web server 11p. A Web page 20 typically contains parts such as texts, pictures, movies, etc. In FIG. 2, parts 201, 202, and 203 are text parts, and parts 204, 205, 206, and 207 are picture parts.

Parts 205, 206, and 207 are areas for the display of banners, i.e., “banner areas”. The page data set 44 contains instructions for obtaining and displaying banners in the banner areas 205, etc. (i.e., 205, 206, and/or 207) as well as a URL (Uniform Resource Locator) of the banner distribution server 13 as an address data set indicating a network address in the Internet of a source node of the banners.

The terminal device 14a transmits a request for the banners to the URL contained in the page data set 44 in accordance with the instructions in the page data set 44. In response to the request, the banner distribution server 13 transmits the banners to the terminal device 14a, and the terminal device displays the banners in the banner areas 205, etc.

In one embodiment, each Web page 20 contains a plurality of banners. The banner distribution server 13 distinguishes one banner area 205, etc. from another banner area 205, etc. in the Web page 20. The banner distribution server 13 records associations between banners and the banner areas 205, etc. Plural banners may be associated with one banner area 205, etc. For example, when a plurality of banners is associated with a banner area 205 and when the banner distribution server 13 receives a request for a banner to be displayed in the banner, the banner distribution server selects one banner from among the plurality of banners randomly, or by following a predetermined rule, and transmits the selected banner to the requesting terminal device 14a. Accordingly, the Web page 20 displayed by one terminal device 14a and the Web page 20 displayed by another terminal device 14b may contain a different banner in the same banner area 205. Similarly, the Web pages 20 displayed by a terminal device 14a at different times may contain a different banner in the same banner area 205.

In one embodiment, a URL of a Web page (not shown) that relates to a banner is linked to the banner. Namely, a banner data set 40 usually contains an instruction to obtain a page data set 44 of a Web page relating to the banner and a URL of a source node of the page data set 44. Accordingly, when a user of the terminal device 14a uses a mouse to click the banner, the terminal device transmits a request for a page data set 44 to the URL contained in the banner data set 40 of the banner that is clicked. When the terminal device 14a receives the page data set 44 from a Web server 11a in response to the request, the terminal device displays a new Web page (not shown) in accordance with the newly received page data set 44.

Banners to which URLs are linked as explained above are frequently used for distributing advertisements, since such banners are efficient means for distributing advertisements to the consumer public. Namely, a banner may show a simple advertisement to attract attentions of potential consumers, and a detailed advertisement is provided by a new Web page (not shown) to the potential consumers only when they are interested in the advertisement shown in the banner and make a simple operation such as clicking the banner.

The banner generating device 12 stores a plurality of advertisement data sets 42, periodically obtains updated feeds 41 from Web servers 11a, etc., selects an advertisement data set 42 relating to each newly obtained feed 41, and generates a banner data set 40 containing contents of the feed 41 and the selected advertisement data set 42. A banner data set 40 containing contents of a feed 41 and an advertisement data set 42 is referred to as a ‘feed banner data set with advertisement’ 43 hereinafter. Feed banner data sets with advertisements 43 generated by the banner generating device 12 are transmitted to the banner distribution server 13 in response to requests periodically received from the banner distribution server 13.

The banner generating device 12 is programmed to count how many times each advertisement is displayed in banners at the terminal devices 14a, etc. in accordance with feed banner data sets with advertisements 43. (This function is referred to as a ‘function for counting advertisement displays’, and a banner displayed in accordance with a feed banner data set 40 with advertisement is referred to as a ‘feed banner with advertisement’ hereinafter.) To provide the function for counting advertisement displays, the banner generating device 12 adds an instruction to display a small picture with no color to each feed banner data set 40 with advertisement when the feed banner data set 40 with advertisement is generated. A request for the small picture made in accordance with the instruction is generally called a ‘beacon’.

A beacon is a request for a picture data set indicating an area of, for example, one by one pixel with no color, and a file name of the picture data set indicates an identifier of an advertisement. For example, a feed banner data set 40 with advertisement that instructs a terminal 14a to display a feed banner with an advertisement identified by an advertisement ID “abcd1234” contains an instruction to obtain a picture data set with a file name of “abcd1234.gif” and a URL of the banner generating device 12 as a source node of the picture data set. When the feed banner with advertisement is displayed by the terminal device 14a, a request for a picture data set identified by the file name of “abcd1234.gif” is transmitted from the terminal device to the banner generating device 12.

The request for the picture data set transmitted from the terminal device 14a is recognized by banner generating device 12 as a notification that an advertisement identified by the advertisement ID “abcd1234” was displayed at the terminal device. Accordingly, the banner generating device 12 can count the number of displays of each advertisement by counting number of requests for picture data sets with respect to each of their file names. The technique of indicating advertisement IDs in file names of picture data sets is one of a lot of possible ways to transmit advertisement IDs from terminal devices 14a, etc. to the banner generating device 12, and any way in which advertisement IDs are transmitted to the banner generating device 12 may be adopted in various embodiments of the present invention.

The banner distribution server 13 receives a request for a banner data set 40 from any terminal device 14a, etc. in the terminal device group 14, and transmits the banner data set 40 to the terminal device in response to the request. When a terminal device 14a receives a page data set 44 of a Web page 20 containing a banner from a Web server 11a, the terminal device transmits a request for a banner data set 40 to the URL of the banner distribution server 13 that is contained in the page data set 44. The request contains an identifier of banner area 205, etc. in the Web page 20. When the banner distribution server 13 receives the request, the banner distribution server selects one of the banner data sets 40 associated with a banner area 205, etc. identified by the identifier of banner area contained in the request, and transmits the selected banner data set 40 to the terminal device 14a, etc.

The terminal device group 14 comprises the terminal devices 14a, etc., each of which is used by a general user who obtains information via the Internet. In FIG. 1, the terminal devices 14h, 14i, and 14j are shown as samples of terminal devices in the terminal device group 14. Each of the terminal devices 14a, etc. in the terminal device group 14 obtains page data sets 44 from the Web servers 11a, etc. in the Web server group 11 and displays Web pages 20 on their screens in accordance with the obtained page data sets 44, following instructions of a program generally called a ‘browser’.

In one exemplary embodiment, each Web server 11a, etc. in the Web server group 11 comprises the following elements: a storing unit 111, a receiving unit 112, and a transmitting unit 113. The storing unit 111 stores page data sets 44 containing instructions for displaying a Web page 20. The receiving unit 112 receives requests for page data sets 44 from the terminal devices 14a, etc. in the terminal device group 14. The transmitting unit 113 transmits page data sets 44 to the terminal devices 14a, etc. in response to requests received by the receiving unit 112.

When a Web server 11a, etc. distributes feeds, the storing unit 111, the receiving unit 112, and the transmitting unit 113 of the Web servers perform the following processes.

The storing unit 111 stores feeds. The receiving unit 112 receives requests for feeds that are periodically transmitted from the banner generating device 12. The transmitting unit 113 transmits feeds to the banner generating device 12 in response to the requests received by the receiving unit 112.

Feeds stored by the storing unit 111 may be either separated from their corresponding page data sets 44 or contained in their corresponding page data sets 44. Feeds are updated when their corresponding page data sets 44 are updated.

In one embodiment, the banner generating device 12 comprises a storing unit 121, a transmitting unit 122, a receiving unit 123, a selecting unit 124, a generating unit 125 and a counter 126. The storing unit 121 stores advertisement data sets 42 each of which indicates an advertisement that is prepared by, or on behalf of, an advertiser. The storing unit 121 also temporally stores feeds received from the Web servers 11a, etc. until feed banner data sets with advertisements 43 are generated using the feeds. The storing unit 121 also temporally stores feed banner data sets 40 generated by the banner generating device 12 until they are transmitted to the banner distribution server 13.

The transmitting unit 122 periodically transmits requests for updated feeds to each Web server 11a, etc. that performs distribution of feeds. The transmitting unit 122 also transmits feed banner data sets with advertisements 43 to the banner distribution server 13 in response to requests periodically received from the banner distribution server 13. The transmitting unit 122 also transmits picture data sets to terminal devices in response to beacons received from terminal devices 14a, etc. in terminal device group 14.

The receiving unit 123 receives feeds that are transmitted from Web servers 11a, etc. in response to requests from the transmitting unit 122. The receiving unit 123 also receives requests for banner data sets 40 periodically transmitted from the banner distribution server 13. In addition, the receiving unit 123 receives beacons transmitted from the terminal devices 14a, etc. in the terminal device group 14.

The selecting unit 124 selects an advertisement data set 42 relating to a newly received feed from among plural advertisement data sets 42 stored by the storing unit 121 each time the receiving unit 123 receives a new feed.

The generating unit 125 generates a feed banner data set 40 with advertisement containing a feed that is newly received by the receiving unit 123 and an advertisement data set 42 that is selected by the selecting unit 124.

The counter 126 counts number of displays of an advertisement on the basis of advertisement IDs transmitted, together with beacons, from the terminal devices 14a, etc. in the terminal device group 14.

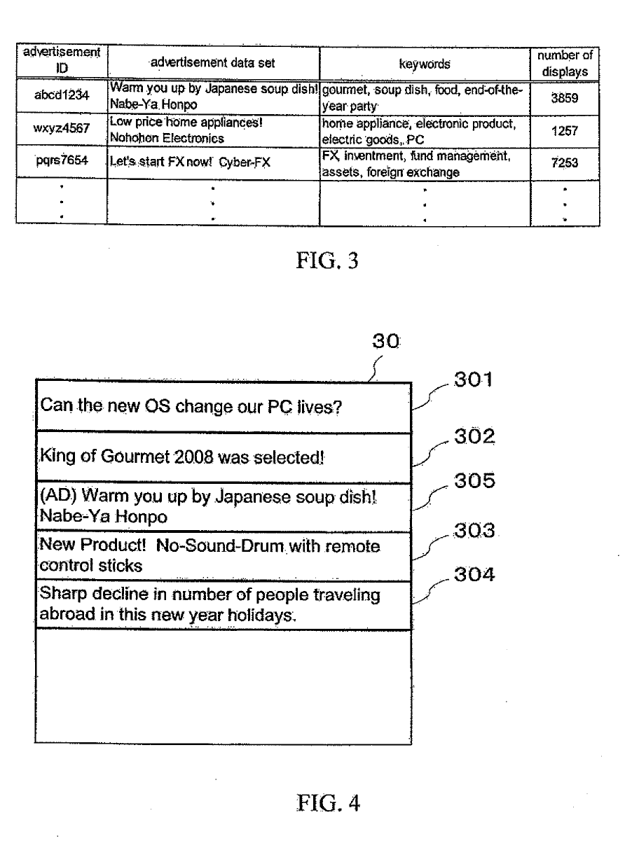

In the present embodiment, advertisement data sets 42 are stored by the storing unit 121 as partial data sets of a database 1211. FIG. 3 illustrates a sample structure of the database 1211, but the invention is not limited in this regard, and in other embodiments, the database may be structured differently from what is shown in FIG. 3. In the illustrated embodiment, the database 1211 comprises plural records each of which contains data of an advertisement identified by an advertisement ID. Each of the records of the database 1211 comprises a field labeled “advertisement ID” for storing an advertisement ID for identifying an advertisement, a field labeled “advertisement data set” for storing an advertisement data set 42, a field labeled “keywords” for storing keywords that are used when selecting unit 124 selects advertisement data sets 42, and a field labeled “number of displays” for storing number indicating how many times the advertisement was displayed at the terminal devices 14a, etc.

When a new feed is received by the receiving unit 123, the selecting unit 124 searches records from the database 1211 using keywords contained in the newly received feed as a search key. Then, the selecting unit 124 selects an advertisement data set 42 in the searched record, and hands it over to the generating unit 125 as an advertisement data set 42 to be used for generating a feed banner data set 40 with advertisement. In this step, the selecting unit 124 may select plural advertisement data sets 42 and hand them over to the generating unit 125.

FIG. 4 illustrates a sample of a feed banner 30 with advertisement that is displayed in the screen in accordance with a feed banner data set 40 with advertisement generated by the generating unit 125. The feed banner 30 with advertisement contains parts 301 to 305. Each of the parts 301 to 304 shows a content of a feed that the receiving unit 123 received from, for example, the Web server 11a, and part 305 shows a content of an advertisement data set 42 that the selecting unit 124 selected.

The advertisement shown in part 305 in FIG. 3 is a content of an advertisement data set 42 identified by the advertisement ID “abcd1234”. The word “gourmet” contained in the feed shown in part 302 is included in keywords of advertisement data set 42 identified by the advertisement ID “abcd1234”, and this is why the advertisement shown in part 305 was selected. Accordingly, the feed banner data with advertisement is generated so that part 305 should be displayed just next to part 302.

The feed banner 30 with advertisement contains a picture indicated by a picture data set with the file name “abcd1234.gif” that is received in response to a beacon for counting number of displays of the advertisement in part 305. However, the picture has no color and it is invisible to the user of a terminal device 14a, etc.

In one embodiment, the distribution server 13 comprises a receiving unit 131, a storing unit 132, a selecting unit 133, and a transmitting unit 134.

The receiving unit 131 receives banner data sets 40 from the Web servers 11a, etc. via terminal devices (not shown) of administrators of the Web servers, and from the banner generating device 12. The receiving unit 131 also receives requests for banner data sets 40 from terminal devices 14a, etc. in the terminal device group 14.

The storing unit 132 stores banner data sets 40 received by the receiving unit 131.

The selecting unit 133 selects a banner data set 40 to be transmitted to a requesting terminal device 14a, etc. from among plural banner data sets 40 stored by the storing unit 132 each time the receiving unit 131 receives a request for banner data set 40.

The transmitting unit 134 periodically transmits requests for banner data sets 40 to the banner generating device 12. The transmitting unit 134 also transmits a banner data set 40, that is selected by the selecting unit 133 in response to a request for the banner data set 40 received by the receiving unit 131, to the requesting terminal device 14a, etc.

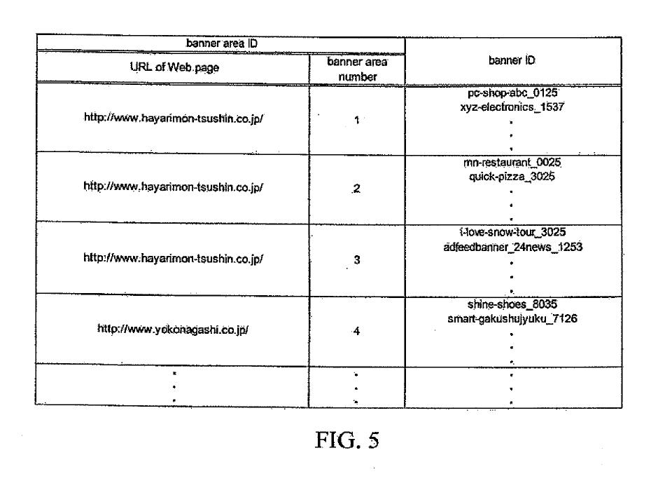

In one embodiment, the storing unit 132 stores a database 1321 for managing banner data sets 40. FIG. 5 illustrates a sample structure of a database 1321, but the invention is not limited in this regard, and in other embodiments, the database may be structured differently from what is shown in FIG. 5. The database 1321 comprises plural records each of which contains data of a banner area 205, etc. identified by a banner area ID. Each of records of the database 1321 comprises a field “URL of Web page” for storing a URL of a Web page 20 containing the banner area 205, etc., a field “banner area number” for storing a number for identifying the banner area in the Web page, and field “banner ID” for storing a banner ID for identifying a banner to be displayed in the banner area. A URL of a Web page 20 and a banner area number are combined to become a banner area ID, and banner areas 205, etc. in different Web pages 20 are distinguished from each other by their banner area IDs.

As shown in FIG. 5, plural banners may be associated with one banner area 205, etc. In FIG. 5, the database 1321 contains a record that stores “http://www.hayarimon-tsushin.co.jp/” in field “URL of Web page” and “3” in field “banner area number” stores plural banner IDs, and one of the plural banner IDs is “adfeedbanner_{—}24news_{—}1253”. This banner ID identifies a feed banner data set 40 with advertisement. In this way, the banner distribution server 13 treats feed banner data sets with advertisements 43, which are transmitted from the banner generating device 12 to the banner distribution server 13, and normal banner data sets 40 in the same manner.

In general, a banner data set 40 may be updated. Namely, an old banner data set 40 may be replaced with a new banner data set 40 without changing their banner IDs. Accordingly, when a banner data set 40 is updated, there is no need to update the contents of the database 1321. Feed banner data sets with advertisements 43 are periodically and automatically updated, and normal banner data sets 40 may be updated in a different manner.

For example, when a banner data set 40 identified by a banner ID “adfeedbanner_{—}24news_{—}1253” contains a content of feed distributed from the Web server 11a, which is managed by 24 News Ltd. and distributes feeds of topical news, a feed banner data set 40 with advertisement that contains an old topic provided by 24 News Ltd. is replaced with a feed banner data set 40 with advertisement that contains a new topic provided by 24 News Ltd. received from the banner generating device 12, and both of the old feed banner data set 40 with advertisement and the new feed banner data set 40 with advertisement are identified by the same banner ID “adfeedbanner_{—}24news_{—}1253”.

In the present embodiment, when the selecting unit 133 receives a request for a banner data set 40 from a terminal device 14a, etc., the selecting unit 133 searches for a record from the database 1321 using a banner area ID in the request as a search key, and randomly selects one banner ID from among banner IDs in the searched record. Then, the selecting unit 133 hands over a banner data set 40 identified by the selected banner ID to the transmitting unit 134 as a banner data set 40 to be transmitted to the requesting terminal device 14a, etc.

There are many ways for the selecting unit 133 to select a banner data set 40 other than randomly in a system according to the present invention. For example, the probability of selection of each candidate banner data set 40 may be determined in advance, and the selecting unit 133 may select a banner data set 40 from among the candidate banner data sets 40 based on their probabilities of selection. The selecting unit 133 also may select a banner data set 40 from among a plurality of candidate banner data sets 40 based on the timing of the selection. Moreover, the selecting unit 133 may exclude a particular banner data set 40 from selection when a number of displays of that banner data set 40 in a certain period of time exceeds a predetermined threshold number.

In one embodiment, each terminal device 14a, etc. in the terminal device group 14 comprises an operating unit 141, a transmitting unit 142, a receiving unit 143, and a displaying unit 144.

In one embodiment, the operating unit 141 is an inputting device that generates and outputs predetermined signals in accordance with operations made by a user, such as a keyboard and a mouse.

The transmitting unit 142 transmits a request for a page data set 44 to a Web server 11a, etc. in the Web server group 11. The transmitting unit 142 also transmits to the banner distribution server 13, when the page data set 44 received from the Web server 11a, etc. contains a banner area 205, etc., a request for a banner data set 40 to be displayed in the banner area. In addition, when the banner data set 40 obtained from the banner distribution server 13 is a feed banner data set 40 with advertisement, the transmitting unit 142 transmits a beacon to the banner generating device 12 in accordance with the instruction contained in the banner data set 40.

The receiving unit 143 receives a page data set 44 that is transmitted from a Web server 11a, etc. in response to a request from the transmitting unit 142. The receiving unit 143 also receives a banner data set 40 that is transmitted from the banner distribution server 13 in response to a request from the transmitting unit 142. In addition, the receiving unit 143 receives a picture data set that is transmitted from the banner generating device 12 in response to a beacon from the transmitting unit 142.

The displaying unit 144 displays a Web page in accordance with a page data set 44 and a banner data set 40 received by the receiving unit 143.

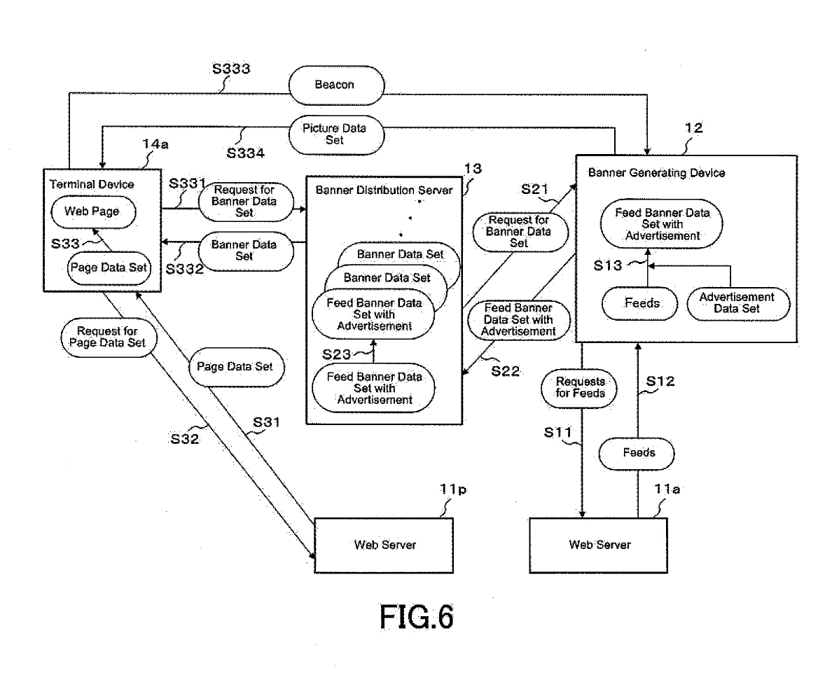

Next, the operation of the advertisement distribution system 1 will be explained with reference to FIG. 6 in an exemplary case where a terminal device 14a displays a Web page 20 in accordance with a page data set 44 with a banner area that is obtained from the Web server 11p. However, the invention is not limited in this regard, and it will be understood that in other embodiments, the system will operate similarly through the use of other terminal devices, web pages and web servers.

In this illustrative embodiment, the banner generating device 12 stores advertisement data sets 42 in the storing unit 121 in advance. Each advertisement data set 42 indicates an advertisement that is prepared by, or on behalf of, an advertiser and that is to be distributed as a part of a feed banner. The banner distribution server 13 stores banner data sets 40 in the storing unit 132 in advance. Each banner data set 40 indicates a banner that is prepared by, or on behalf of, an administrator of a Web server and that is to be displayed in a Web page 20.

In this exemplary case, an administrator of the Web server 11p has saved in the banner distribution server 13 a feed banner with advertisement that contains a feed distributed from the Web server 11a as one of a plurality of banners that may be displayed in the third banner area 207 in a Web page 20 distributed from the Web server 11p.

In the above-explained situation, the banner generating device 12 transmits requests for feeds to the Web server 11a periodically, for example every 30 minutes (Step S11). The Web server 11a transmits the newest feed data to the banner generating device 12 each time when a request is received in Step S11 (Step S12).

When the banner generating device 12 receives the newest feed data in Step S12, the banner generating device selects an advertisement data set 42 that relates to the received feed, and generates a feed banner data set 40 with advertisement using the feed and the selected advertisement data (Step S13). Namely, the feed banner data generated in Step S13 contains the feed distributed from the Web server 11a.

In parallel with Steps S11 to S13, the banner distribution server 13 transmits requests for feed banner data sets with advertisements 43 to the banner generating device 12 periodically, for example every 10 minutes (Step S21). The banner generating device 12 transmits a feed banner data set 40 with advertisement, that is generated in Step S13 and has not yet been transmitted to the banner distribution server 13 to the banner distribution server 13 each time a request is received in Step S21 (Step S22). The banner distribution server 13 overwrites an old feed banner data with a new feed banner data received in Step S22 (Step S23).

When the operations of Steps S11 to S13 are repeatedly performed, for example every 30 minutes, and the operations of Steps S21 to S23 are repeatedly performed, for example every 10 minutes, when a user of the terminal device 14a inputs a URL of the Web server 11p, for example “http://www.hayarimon-tsushin.co.jp/”, in the area for inputting a URL in the browser and instructs the browser to display a Web page, the terminal device 14a transmits a request for a page data set 44 to Web server 11p in accordance with the inputted URL (Step S31).

The Web server 11p transmits a page data set 44, which instructs a terminal device 14a, etc. to display a Web page 20 of its Web site, to the terminal device 14a in response to the request received in Step S31 (Step S32). The page data set 44 transmitted to the terminal device 14a in Step S32 contains instructions for displaying banners.

The terminal device 14a displays a Web page 20 in accordance with the page data set 44 received in Step S32 (Step S33). In the course of displaying the Web page 20 in Step S33, the terminal device 14a transmits to the banner distribution server 13, a request for a banner data set 40 for each of the banner areas 205, etc. contained in the Web page (Step S331). Each of the requests that are transmitted to the banner distribution server 13 in Step S331 contains a banner area ID of the banner area 205, etc.

The banner distribution server 13 randomly selects a banner data set 40 from among candidate banner data sets 40 associated with each of the banner areas 205, etc. in response to the requests received in Step S331, and transmits the selected banner data sets 40 to the terminal device 14a (Step S332). The terminal device 14a receives the banner data sets 40 in Step S332 and displays banners in the banner areas 205, etc. in the Web page 20 in accordance with the received banner data sets 40.

For example, in a case where the database 1321 contains data shown in FIG. 5, the banner data set 40 that the terminal device 14a receives in Step S332 for the third banner area may be a feed banner data set 40 with advertisement. If the terminal device 14a receives a feed banner data set 40 with advertisement, the terminal device 14a transmits a beacon to the banner generating device 12 in accordance with an instruction contained in the received feed banner data set 40 (Step S333).

When the banner generating device 12 receives the beacon in Step S333, the banner generating device 12 searches a record from the database 1211 using an advertisement ID received together with the beacon as a search key, and increases the value of field “number of displays” of the searched record by one. Then, the banner generating device 12 transmits a picture data set to the terminal device 14a in response to the request (Step S334).

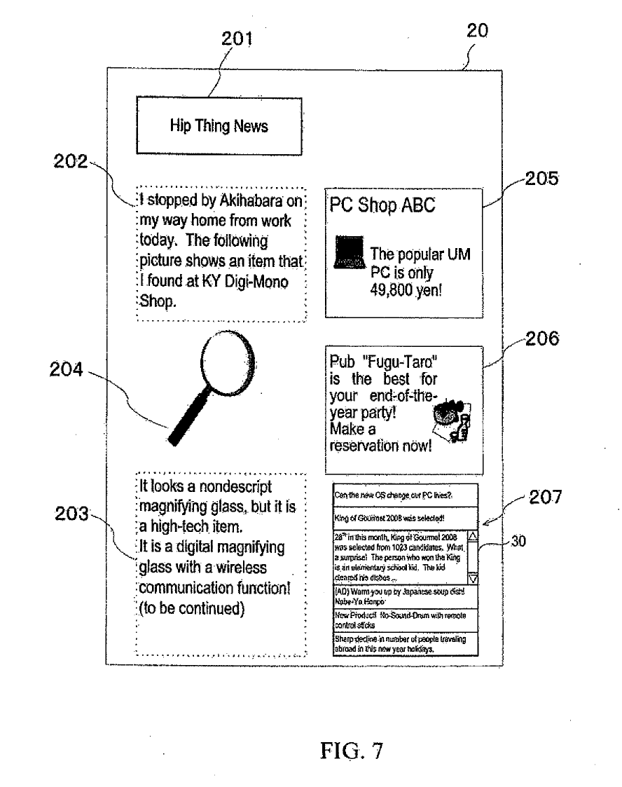

FIG. 7 illustrates a Web page 20 containing a feed banner 30 with advertisement displayed by the terminal device 14a. In FIG. 7, the feed banner 30 that contains the newest feeds 24 News Ltd. and an advertisement related to one of the feeds is shown as part 207, i.e., as the banner area 207.

The feed banners 30 with advertisements that are shown in Web pages 20 may be interactively animated by the use of known technologies such as Flash. (Flash is software that is originally acquired by Macromedia Inc. and currently developed and distributed by Adobe Systems Inc.) When such technologies are utilized, for example, the following interactive provision of information may be achieved: when a user operates a mouse to click any one of parts 301 to 304, a detailed news data set linked to the clicked part is obtained from the Web server 11a and is displayed, and when the user operates the mouse to click part 305, a detailed advertisement data set 42 linked to part 305 is obtained from a Web server 11p, etc. of an advertiser and is displayed.

As explained above, according to advertisement distribution system 1, a terminal device 14a, etc. is enabled to display feeds distributed from Web servers 11a, etc. and advertisements related to the feeds in Web pages 20 without equipping each intermediate node with the advertising supplement function or forcing each terminal device 14a, etc. to obtain feeds via a predetermined proxy server. Accordingly, the invention provides an efficient system for distributing advertisements with low cost and low difficulty.

The above explained embodiment may be modified in many ways within the scope of the technical idea of the present invention. Some exemplary modifications will be explained in the following paragraphs.

In the above explained embodiment, when the banner generating device 12 obtains the newest feeds, requests for the feeds are transmitted from the banner generating device 12 to Web servers 11p, etc. distributing the feeds. The present invention should not be limited such that the transmissions of feeds to a banner generating device 12 are triggered by actions made by the banner generating device 12. For example, the Web servers 11p, etc. may distribute the newest feeds to the banner generating device 12 periodically, or each time the feeds are updated, without waiting for requests from the banner generating device 12.

In the above explained embodiment, when the banner distribution server 13 obtains the newest feed banner data sets with advertisements 43, requests for the banner data sets 40 are transmitted from a banner distribution server 13 to a banner generating device 12. The present invention should not be limited such that the transmissions of feed banner data sets 40 to a banner distribution server 13 are triggered by actions made by the banner distribution server 13. For example, the banner generating device 12 may distribute the newest feed banner data sets 40 to the banner distribution server 13 periodically or each time when the feed banner data sets 40 are updated, without waiting for requests from the banner distribution server 13.

In the above explained embodiment, a banner distribution server 13 is a device that is physically independent from either any one of Web servers 11a, etc. in the Web server group 11 or the banner generating device 12. The present invention should not be limited such that these devices are physically independent from each other, and for example, (1) any one of Web servers 11a, etc. in the Web server group 11 may be equipped with the functions of banner distribution server 13, or (2) the banner generating device 12 may be equipped with the functions of the banner distribution server 13.

When a page data set 44 and banner data sets 40 for the page data are distributed from the same Web server 11a, the system becomes the above mentioned modified case (1). In the case, with regard to the Web site, both of the Web server 11a and the banner distribution server 13 are realized by the same physical device. In such case, the Web server 11a and the banner distribution server 13 may be either different nodes or the same node in the device.

In the above mentioned modified case (2), there is no need for the banner generating device 12 to transmit banner data sets 40 to the banner distribution server 13. Similarly in the modified case (1), the banner generating device 12 and the banner distribution server 13 may be either different nodes or the same node in the device.

Each of the elements composing the above explained advertisement distribution system 1 may be realized either by a combination of plural pieces of hardware, each of which achieves a function of the element, or by letting a computer having general components conduct processing in accordance with instructions of an application program. The present invention also provides a program for letting a general computer function as the above explained banner generating device, and a computer readable recording medium storing the program.

In the above explained embodiment, the banner generating device 12 uses an advertisement data set 42 for generating a feed banner data set 40. The present invention should not be limited such that an advertisement data set 42 is always included in a feed banner data set 40. Namely, when no advertisement data set 42 relates to feeds in a feed banner data set 40, the banner generating device 12 may generate a feed banner data set 40 without advertisement, and the feed banner data set 40 without advertisement may be transmitted to the banner distribution server 13.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced item.

Although the invention has been described with reference to particular embodiments thereof, it will be understood by one of ordinary skill in the art, upon a reading and understanding of the foregoing disclosure, that numerous variations and alterations to the disclosed embodiments will fall within the scope of this invention and of the appended claims.

1. (canceled)

2. A system comprising:
a first storing unit that stores feeds;
a first transmitting unit that transmits feeds stored by the first storing unit;
a second storing unit that stores advertisement data sets;
a first receiving unit that receives feeds from the first transmitting unit;
a generating unit that generates part data sets from advertisement data sets stored by the second storing unit and feeds received by the first receiving unit;
a third storing unit that stores part data sets generated by the generating unit;
a second receiving unit that receives requests for part data sets; and
a second transmitting unit that transmits part data sets stored by the third storing unit in response to requests received by the second receiving unit to source nodes of the requests, the requests being transmitted from source nodes in accordance with instructions contained in page data sets received from a third transmitting unit;
a fourth storing unit that stores page data sets each of which contains an instruction to obtain a part data set stored by the third storing unit; and
a third receiving unit that receives requests for page data sets, the requests being transmitted from arbitrary nodes;
wherein the third transmitting unit transmits page data sets stored by the fourth storing unit in response to requests received by the third receiving unit to the arbitrary nodes.

3. The system of claim 2, comprising:
a first node that distributes feeds, the first node including the first storing unit and the first transmitting unit;
a second node including the second storing unit, the first receiving unit, the generating unit, the third storing unit, the second receiving unit, and the second transmitting unit; and
a third node that distributes page data sets, each of which instructs to display a page, in response to requests from source nodes, the third node including the fourth storing unit, the third receiving unit, and the third transmitting unit.

4. The system of claim 2, comprising:
a fourth transmitting unit that transmits part data sets generated by the generating unit; and
a fourth receiving unit that receives part data sets from the fourth transmitting unit;
wherein the third storing unit stores part data sets received by the fourth receiving unit.

5. The system of claim 4, comprising:
a first node that distributes feeds, the first node including the first storing unit and the first transmitting unit;
a second node including the second storing unit, the first receiving unit, the generating unit, and the fourth transmitting unit;
a third node that distributes part data sets, each of which indicates a part composing a page, in response to requests from arbitrary nodes, the third node including the third storing unit, the second receiving unit, the second transmitting unit, and the fourth receiving unit; and
a fourth node that distributes page data sets, each of which instructs to display a page, in response to requests from arbitrary nodes, the fourth node including the fourth storing unit, the third receiving unit, and the third transmitting unit.

6. The system of claim 4, comprising:
a first node that distributes feeds, the first node including the first storing unit and the first transmitting unit;
a second node including the second storing unit, the first receiving unit, the generating unit, and the fourth transmitting unit; and
a third node including the third storing unit, the second receiving unit, the second transmitting unit, the fourth storing unit, the third receiving unit, the third transmitting unit, and the fourth receiving unit.

7. The system of claim 2, wherein the second storage unit is configured to store an advertisement data set which contains a network address of a Web server relating to the advertisement data set as a linked address.

8. The system of claim 2, wherein the generating unit generates a part data set which contains an instruction to transmit a beacon to the system, the beacon being a request for a picture data set accompanied by an identifier of an advertisement data set;
the system further comprising a beacon receiving unit that receives beacons from arbitrary nodes; and
a counter that counts number of beacons that are received by the beacon receiving unit with respect to each identifier of advertisement data set accompanying the beacons.

9. A method comprising:
transmitting a feed from a first node to a second node;
generating, at the second node, a data set by use of the feed and an advertisement data set stored at the second node;
storing the generated data set as a part data set, which indicates a part composing a page,
transmitting a request for a page data set from an arbitrary node to a third node, the third node being a node that distributes page data sets which include instructions to display web pages, in response to requests from arbitrary nodes;
transmitting a page data set from the third node to the arbitrary node in response to the request transmitted from the arbitrary node to the third node, the page data set containing an instruction to obtain the part data set;
obtaining, at the arbitrary node, the part data set in accordance with the instruction contained in the page data set transmitted from the third node, and
displaying, at the arbitrary node, a page containing a part indicated by the part data set.

10. The method of claim 9, including storing the data set at the second node.

11. The method of claim 9, including transmitting the data set generated at the second node from the second node to a fourth node as a part data set, which indicates a part composing a page, the fourth node being a node that distributes part data sets in response to requests from arbitrary nodes.

12. The method of claim 9, including transmitting the data set generated at the second node from the second node to the third node as a part data set, which indicates a part composing a page, the third node being a node that distributes part data sets in response to requests from arbitrary nodes.

13. The method of claim 9, including, wherein the advertisement data set contains a network address of a web server relating to the advertisement data set as a linked address.

14. An apparatus comprising:
an advertisement data set storing unit that stores advertisement data sets;
a feed receiving unit that receives feeds from a first node;
a generating unit that generates data sets from advertisement data sets stored by the advertisement data set storing unit and feeds received by the feed receiving unit; and
a transmitting unit that transmits part data sets to a second node. (* Please note that the second node of claim 15 may not send requests for the part data sets to the subject apparatus.)

15. The apparatus of claim 14, wherein the transmitting unit transmits the data sets generated by the generating unit to a second node as part data sets, each of which indicates a part composing a page, the second node being a node that distributes part data sets in response to requests from source nodes.

16. The apparatus of claim 14, including:
a part data set storing unit that stores the data sets generated by the generating unit as part data sets, each of which indicates a part composing a page; and
a request receiving unit that receives requests for part data sets, each of the requests being transmitted from an arbitrary node in accordance with an instruction contained in a page data set that the arbitrary node obtains from another node;
wherein the transmitting unit transmits to source nodes of the requests the part data sets stored by the part data set storing unit, in response to requests received by the request receiving unit.

17. The apparatus of claim 14, wherein:
the advertisement data set storing unit stores plural advertisement data sets;
the feed receiving unit receives a feed from the first node each time a predetermined condition is fulfilled; and
the generating unit selects, each time the feed receiving unit receives a feed from the first node, an advertisement data set that has a predetermined relationship with the received feed from among the plural advertisement data sets stored by the advertisement data set storing unit, and generates the data set from the received feed and the selected advertisement data set.

18. The apparatus of claim 14, wherein the advertisement data set storage unit is configured to store an advertisement data set which includes a network address of a Web server relating to the advertisement data set as a linked address.

19. The apparatus of claim 14, wherein the generating unit generates the data set which contains an instruction to transmit a beacon to the apparatus in addition to an advertisement data set and a feed, the beacon being a request for a picture data set accompanied by an identifier of the advertisement data set;
the apparatus further comprising:
a beacon receiving unit that receives beacons from arbitrary nodes, and
a counter that counts number of beacons that are received by the beacon receiving unit with respect to each identifier of advertisement data set accompanying the beacons.

20. A computer-readable storage medium having computer-executable code stored therein, including code being usable by a computer that has ability to communicate with external nodes via a network, including code for:
storing advertisement data sets;
receiving feeds from a first node;
generating data sets from the advertisement data sets and the feeds; and
transmitting the generated data sets to a second node.

21. The computer-readable storage medium of claim 20, including code for transmitting the generated data sets to the second node as part data sets, each of which indicates a part composing a page, the second node being a node that distributes part data sets in response to requests from arbitrary nodes.

22. The computer-readable storage medium of claim 20, including code for:
storing the generated data sets as part data sets, each of which indicates a part composing a page;
receiving requests for part data sets, each of the requests being transmitted from an arbitrary node in accordance with an instruction contained in a page data set that the arbitrary node obtains from another node; and
transmitting, in response to the requests, the part data sets to source nodes of the requests.

23. A computer that has ability to communicate with external nodes via a network, the computer including code for:
storing advertisement data sets;
receiving feeds from a first node;
generating data sets from the advertisement data sets and the feeds; and
transmitting the generated data sets to a second node.

24. The computer of claim 23, including code for transmitting the generated data sets to the second node as part data sets, each of which indicates a part composing a page, the second node being a node that distributes part data sets in response to requests from arbitrary nodes.

25. The computer of claim 23, including code for:
storing the generated data sets as part data sets, each of which indicates a part composing a page;
receiving requests for part data sets, each of the requests being transmitted from an arbitrary node in accordance with an instruction contained in a page data set that the arbitrary node obtains from another node; and
transmitting, in response to the requests, the part data sets to source nodes of the requests.
